(19) United States
(12) Patent Application Publication
(10) Pub. No.: US 2002/0117224 A1
(43) Pub. Date: Aug. 29, 2002

(54) Conduit bundle for controlling fluid flow

(76) Inventor: Ahmad D. Vakili, Tullahoma, TN (US)

Correspondence Address: Frank L. Hart, Attorney at Law, 8911 S. 73rd East Ave., Tulsa, OK, 74133, US

(21) Appl. No.: 10/084,164

(22) Filed: Feb. 28, 2002

Related U.S. Application Data
(60) Provisional application No. 60/271,613, filed on Feb. 26, 2001.

(51) Int. Cl. F15D 1/02

(52) U.S. Cl. 138/39; 138/116; 138/42

(57) ABSTRACT

A honeycomb type bundle of conduits are of various construction to provide a multitude of uses. The primary function of the honeycomb type bundle is to alter the flow path of fluid and produce Uniform flow, uniform turbulence and reduced noise. Because of the unique construction, the bundle has other unexpected uses.

Priority is claimed from provisional application “A New Honeycomb Generating Low Isotropic Turbulence” filed Feb. 26, 2001, by Ahmad D. Vakili, and provided Ser. No. 60/271,613.

### TECHNICAL FIELD

The subject invention relates to a conduit bundle used primarily for altering fluid flow nonuniformity to produce highly uniform flows with low turbulence and acoustic attenuation.

### BACKGROUND ART

The design of a Turbulence Reduction System (TRS) for most wind tunnels is based on not only modifying and reducing turbulence generated in the flow circuit by many sources such as fans, heaters, coolers, turning vanes etc, but also on the requirement for turbulence generated by the TRS itself being small or negligible. To meet these requirements, the stilling chamber is made as large as possible to lower the velocity and honey comb and screen or screens are added for the purpose of modifying the flow properties to result in both reduced amounts of turbulence as well as improved character of turbulence (ideally isotropic turbulence). The screen wire diameter is selected to be very small to achieve sub-critical Reynolds numbers. For large wind tunnels, there are at least two problems associated with this methodology. The first problem is that a wire screen extended over a large span does not retain its intended planar shape. The screen is deformed into a somewhat curved shape that changes the flow direction in proportion to the local inclination of the screen relative to the flow upstream of the screen. The flow downstream of the deformed screen is therefore, non-uniform and results in flow angularity in the test or downstream section (hereinafter “downstream section”). The second problem is the large required crossectional area and length of the stilling chamber necessary to produce the contraction ratio and flow distance that is essential to reducing stream turbulence in the downstream section to the desired value.

On the basis of both material and labor saving and mechanical considerations, the stilling chamber size requirement is especially limiting for the design of high Reynolds number wind tunnels, which are often pressurized and thus, for mechanical reasons, have a circular cross section stilling chamber. High Reynolds number wind tunnels typically have stilling chambers that are smaller in diameter than the lower Reynolds number and have a higher flow velocity for a given downstream test section velocity than a non-pressurized tunnel of the same downstream section size. This places two contradicting requirements on the screens. The screen wire diameter must be kept small to operate at sub-critical Reynolds numbers. Sub-critical Reynolds number corresponds to low velocity flow such that the wake of wires remain laminar and stable without vortex shedding. The wire diameter must be increased to reduce the deformation due to increased loads on the screen. This, in turn, increases the turbulence level in the downstream section that would require a longer section to provide for increased decay of turbulence exiting the last screen. The same is true for wind tunnels with rectangular stilling chambers.

There are many other uses for the subject invention than in wind tunnels. Other uses which benefit from the construction of the conduit bundle include acoustic filters and sound absorbers, air flow distribution systems, such as the nacelle of an engine, energy absorbing systems for absorbing kinetic energy of crash impacts, and applications in fuel cells, to name a few without being an exhaustive list.

The present invention is directed to overcome one or more of the heretofore problems and improve the operation of various other applications of the invention.

### DISCLOSURE OF THE INVENTION

In one aspect of this invention, an apparatus is provided which comprises a plurality of conduits maintained together and defining a conduit bundle, said conduits of said bundle having a porosity sufficient for lateral communication between said conduits of said conduit bundle and including means for maintaining the conduits contacting and positioned one relative to the others.

In another aspect of this invention, a honeycomb type distribution system is provided for generating low isotropic turbulence. A plurality of conduits are connected to one another and define a conduit bundle. The conduits of the bundle have a porosity sufficient for lateral communication between the conduits of the conduit bundle. Means is provided for enclosing said conduit bundle about the length of the bundle and defining a distribution system of general honeycomb configuration free of screen elements.

### BRIEF DESCRIPTION OF THE DRAWINGS

FIG. 1 is a side view in partial section of a wind tunnel having the conduit bundle of this invention;

FIG. 2 is a perspective view of the conduit bundle of this invention showing at least a portion of the outer periphery conduits of the conduit bundle having a porosity;

FIG. 3. is a perspective view of the conduit bundle of this invention showing the outer portion of the periphery conduits of the conduit bundle being non-porous and sealed one to the other;

FIG. 4 is a perspective view of the conduit bundle of this invention showing inner and outer conduits 14,16 of the conduit bundle 2 having porosity over respective different lengths;

FIG. 5 is an end view of the conduit bundle diagrammatically showing the difference in area between the spaces between the conduits and the area of the conduit;

FIG. 6 is a side view of conduits of the conduit bundle which have uniform porosity per unit length in a direction from the inlet toward the outlet;

FIG. 7 is a side view of the conduits of the conduit bundle showing the porosity opening being randomly located;

FIG. 8 is a partial perspective view of the conduits of the conduit bundle with the outer periphery wall portions of the outer periphery conduits of the bundle being free of porosity and the outer periphery conduits connected one to the other;

FIG. 9 is a partial perspective view of conduits of the conduit bundle with said conduits having an inlet of different area that its outlet; and

### BEST MODE FOR CARRYING OUT THE INVENTION

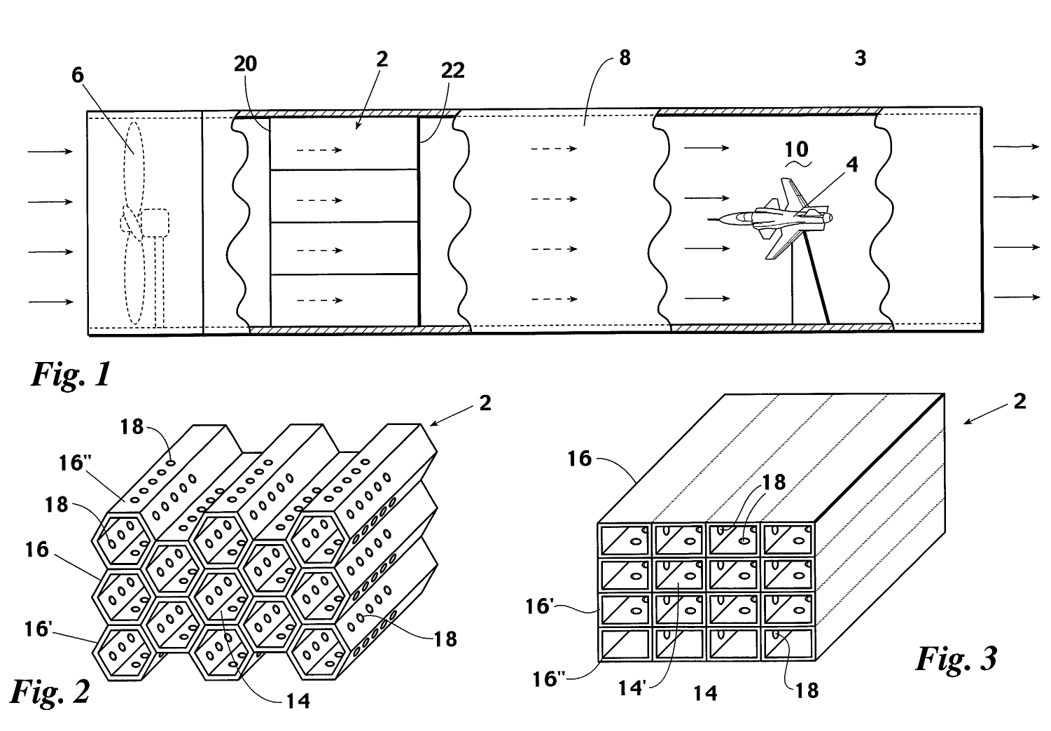

Referring to FIG. 1, the apparatus of this invention or conduit bundle 2, is shown in use in a wind tunnel 3 used for testing the aerodynamic properties of an item 4. As is well known in the art, the wind tunnel 3 has apparatus such as a fan 6 for passing air into an elongated enclosure 8. The air is passed from the fan 6, through the conduit bundle 2 within the enclosure 8 where lower isotropic turbulence is produced and then directly into the test or down stream chamber 10 where the item 4 being investigated is positioned. Preferably, the enclosure 8 is connected to and about the conduit bundle 2 at both inlet and outlet ends 20,22 and functions as one means for maintaining the conduits contacting and positioned one relative to others. The air discharging from the outlet or second end 22 of the conduit bundle 2 passes directly to the item 4 without passing through screen elements which were heretofore used to lower isotropic turbulence. The conduit bundle 2 of the construction of this invention therefore eliminates the need for a screen element while producing improved desired downstream flow properties.

There exists a multiplicity of uses for the conduit bundle 2 of this invention. It should be noted that as the use of the bundle 2 changes, so does various construction aspects of the plurality of conduits 14,16 of the conduit bundle 2.

For purposes of simplification and clarity, numeral 14 and associated prime numbers will be utilized to indicate any conduit residing at an internal location in the bundle 2 and numeral 16 and associated prime numbers will be used to indicate any conduit residing on the outer periphery of the bundle 2.

The purpose for the transverse perforations 18 of each conduit 14,16, as hereinafter more fully described, is to provide porosity and thereby provide near total pressure equilibrium between each of the cells or conduits 14,16 of the conduit bundle 2. Various transverse porosity is obtained through various perforation 18 design, shape, size, number, distribution, orientation, and location on its respective conduit 14/16. The location, pattern, and percentage of the perforations 18, 18′, 18″ in relation to the other geometrical aspects of the honeycomb bundle are at the core of the new honeycomb invention and the observed performance improvements, as will be later more fully described. It should be understood however that each conduit 14,16 of a bundle is in communication with respective adjacent conduits 14,16 of that bundle.

The absence of screen elements in the construction of wind tunnels 3 using the subject invention may reduce overall tunnel power consumption and flow angularity. The lower total pressure loss will manifest itself in a higher tunnel velocity for the same total power consumed. This will result in the saving of energy at comparable operation conditions. In general, distortions in the stilling chamber 10 have relatively small, to moderate gradients. The medium gradients would only result in typically low speed flows through the transverse perforations 18 etc. Therefore, the honeycomb bundle 2 will have only slightly higher losses than the current solid honeycomb of the same length and cell size. Similarly, since the transverse flow rate is expected to be small, the amplitude of noise generated is also quite small.

This invention is adapted for the construction of a conduit bundle 2 having conduits 14,16 of various lengths, thickness and crossectional configuration. The preferred thickness is dependent upon flow speed and uniformity, turbulence level, acoustic attenuation, available space, and ruggedness required. The crossectional configuration is preferably hexagonal. However, the crossectional configuration of each conduit can be circular, non-circular, elliptical, rectangular, square, triangular or of other desired shape. The conduits 14,16 are preferably formed of sheet metal and can have perforations formed on all sides. The perforations can be formed in the finished conduit or in a sheet prior to forming a conduit from the sheet.

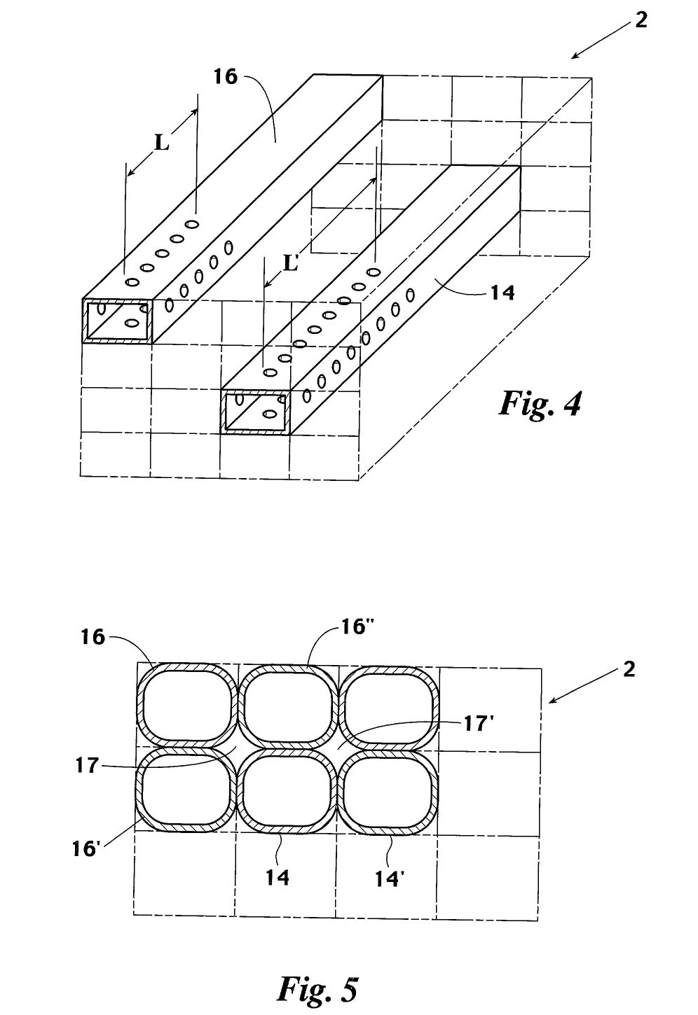

The perforations 18, 18′, 18″ which form the porosity of the conduits 14,16 (See FIG. 4) which permit lateral communication between the conduits 14,16 of the bundle 2 may be elliptical, rectangular, square, hexagonal, triangular or of other shapes. The preferred configuration is circular for providing ease of construction and a savings of labor and material. The perforations 18, 18′18″ can be formed by various methods known in the art, such as by machine punch, for example.

These perforations 18, 18′, 18″ formed along the length of the conduits 14,16 of the conduit bundle, preferably are formed at right angles to the centerline of the respective conduits, and at preselected distances apart as measured from the first or inlet end 20 toward the outlet end 22 of the conduit bundle 2.

The drawings show various configurations of conduits and bundles and it should be understood that other construction variations fall within the scope of this invention so long as there is fluid communication between conduits of a bundle.

Referring to FIG. 2, the conduit wall portions on at least a portion of the outer periphery 16 of the conduit bundle 2 are porous over at least a portion of their length. Such construction provides for pressure alteration outside of the bundle and is particularly useful where the bundle is contained within a vessel or conduit through which fluid is flowing. Examples of such a construction would be a wind tunnel and the nacelle of an engine.

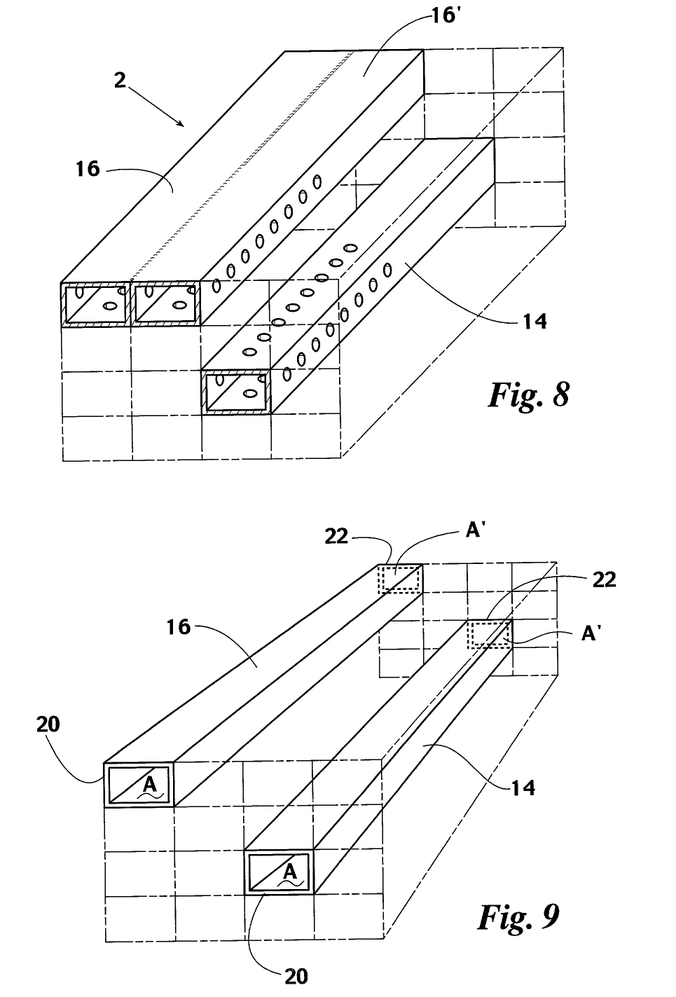

Referring to FIGS. 3 and 8, the conduit wall portions on the outer periphery of the conduit bundle 2 is non porous over their entire length and the outer periphery conduits 16 of the bundle 2 are sealed, by welding or other known means for example, to adjacent conduits 16 of the bundle 2 along the length of the bundle 2. By this construction, the bundle is forming its own retaining walls and the need for a large conduit surrounding the bundle is eliminated. This welding also provides the means for maintaining the conduits touching and positioned one relative to others. Another apparatus for maintaining the conduits relatively positioned would be by metal bands surrounding the conduit bundle. Such construction could advantageously be used in a large wind tunnel where the fan and downstream portions of the tunnel are sealingly connected to the respective inlet and outlet ends of the bundle 2.

Referring to FIG. 4, conduits 14,16 of the conduit bundle 2 each have a porosity over only a portion L of their total length. It should be noted that this porosity portion L is generally adjacent only the inlet ends of the conduits 14,16. In this construction, pressure equalization is achieved upon fluid passage through the initial portion of the bundle 2 and uniform linear flow is induced through the remaining portion of the conduits 14,16 and outwardly therefrom. One skilled in the art can readily determine the length of perforations desired once it is known the properties and volume of fluid expected to be passed through the bundle per unit time. Such determination would not require effort of an inventive nature. The porous length L of each conduit can be substantially the same for each porous conduit 14,16 within the bundle 2 or can be of various lengths L,L′.

Referring to FIG. 5, the crossectional configuration of the conduits 14, 16 of the conduit bundle 2 can be of any configuration so long as any spaces 17,17′ between adjacent conduits of the conduit bundle has a volume less than the volume of one of the conduits 14/16 of the conduit bundle 2.

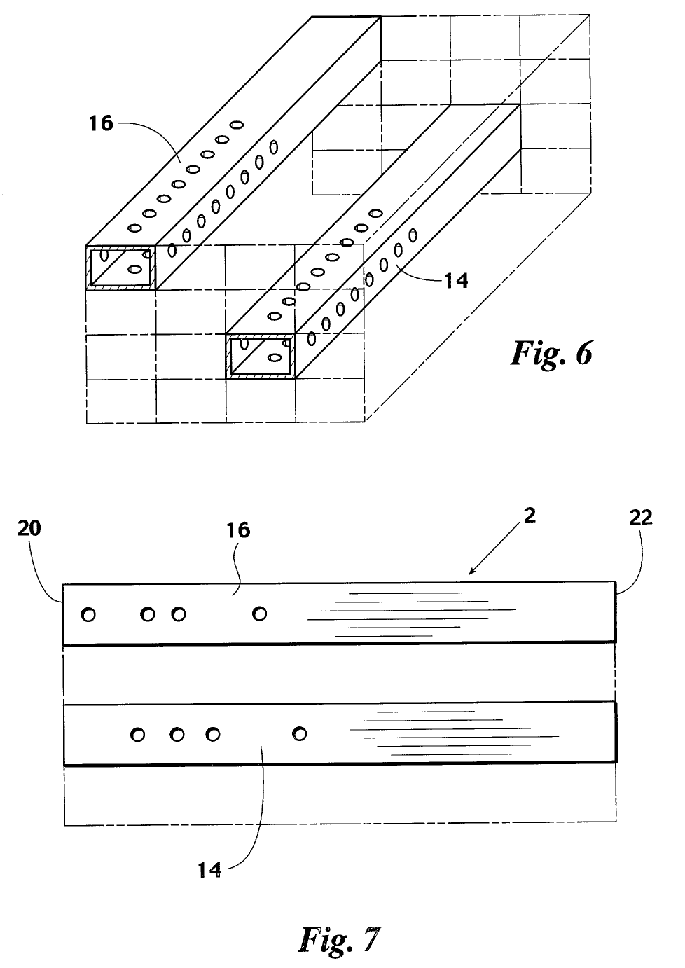

Referring to FIG. 6, the area of porosity openings per unit length for the respective conduit 14 and/or 16 of the conduit bundle is substantially uniform. However, the area of porosity openings per unit length of the respective conduit 14 and/or 16 of the conduit bundle can decrease or increase in a direction from the inlet end 20 toward the outlet end 22 of the conduit bundle 2 for altering the fluid flow characteristics without departing from this invention.

Referring to FIG. 7, the porosity openings are randomly positioned on the conduit and such construction does not depart from this invention.

The openings formed through the wall of the conduit thereby forming the porosity of the conduit can be at right angles relative to the centerline or at any other angle without departing from this invention. It is preferred, however, that the opening be formed at right angles and thereby saving time, labor and materials.

In another embodiment, a construction is provided wherein the first and second ends 20 of the plurality of conduits 14/16 are closed and the enclosing means 8 is porous. Another construction that may be useful would be to have the enclosing means 8 porous. These alternative depend upon the use that is to be made of the bundle 2.

FIG. 9 shows an embodiment of this invention wherein the one end of the plurality of conduits have a crossectional open area “A” different than the crossectional area A′ of the other end 22 of the conduits. Such construction provides a construction whereby one can provide a significant overall pressure drop or increase yet control the turbulence therefrom. Such an embodiment will have uses in diffusers, nozzles, turning ducts at locations upstream or downstream of turns, orifices and even for mixing applications.

### INDUSTRIAL APPLICABILITY

As disclosed above, as fluid passes through the bundle 2 of this invention, the individual conduits of the bundle separate the fluid into separate and distinct units of fluid that are flowing within a respective conduit or along the outer surface between adjacent conduits. As can be readily understood, separate units of higher pressure fluid passing through or about the conduit will pass through the openings of the conduits and into communication with units of fluid which are at a lower pressure By this means, the flow exiting the bundle will be highly uniform and acoustic attenuation will be accomplished.

Other aspects, objects and advantages of this invention can be obtained from a study of the drawings, the disclosure, and the appended claims.

What is claimed is:

1. An apparatus, comprising:
a conduit bundle defined by a plurality of conduits maintained together, said conduits of said bundle having open inlet and outlet ends and a porosity sufficient for lateral communication between said conduits of said conduit bundle; and
means for maintaining the conduits contacting and positioned one relative to others.

2. An apparatus, as set forth in claim 1, wherein the conduit wall portions on at least a portion of the outer periphery of the conduit bundle are porous over at least a portion of their length.

3. An apparatus, as set forth in claim 1, wherein the conduit wall portions on the outer periphery of the conduit bundle are non porous over their entire length and the outer periphery conduits of the bundle are sealed one to adjacent conduits of the bundle along the length of the bundle.

4. An apparatus, as set forth in claim 1, wherein the length of conduit which is porous is uniform for each conduit of the conduit bundle.

5. An apparatus, as set forth in claim 1, wherein the length of conduit which is porous varies within the conduits of the conduit bundle.

6. An apparatus, as set forth in claim 1, wherein the crossectional configuration of the conduits of the conduit bundle is one of any configuration wherein any spaces between adjacent conduits of the conduit bundle has a volume less than the volume of one of the conduits of the conduit bundle.

7. An apparatus, as set forth in claim 1, wherein the crossectional configuration of the conduits of the conduit bundle is hexagonal.

8. An apparatus, as set forth in claim 1, wherein the porosity of the conduits of the conduit bundle includes openings formed through conduit walls.

9. An apparatus, as set forth in claim 8, wherein the area of the porosity openings of each conduit of the conduit bundle is in the range of about 10 to about 90 percentage of the peripheral area of the respective conduit.

10. An apparatus, as set forth in claim 8, wherein the area of porosity openings per unit length of the respective conduit of the conduit bundle is substantially uniform.

11. An apparatus, as set forth in claim 8, wherein the porosity openings are randomly positioned on the conduit.

12. A honeycomb type distribution system for generating low isotropic turbulence, comprising:
a conduit bundle defined by a plurality of conduits maintained together, said plurality of conduits each having first and second opposed ends and a porosity sufficient for lateral communication between said conduits of said conduit bundle; and
means for enclosing said conduit bundle about the length of said bundle and defining a distribution system of general honeycomb configuration free of screen elements.

13. A distribution system, as set forth in claim 12, wherein the means for enclosing said conduit bundle include the conduit wall portions on the outer periphery of the conduit bundle being free of porosity with adjacent outer periphery conduits being connected one to the other along their lengths.

14. A distribution system, as set forth in claim 12, wherein the means for enclosing said conduit bundle includes a non porous conduit having a size sufficient for encompassing the conduit bundle along its length.
